(19) United States
(12) Patent Application Publication
(10) Pub. No.: US 2009/0044503 A1
(43) Pub. Date: Feb. 19, 2009

(54) Filter Element

(75) Inventor: Micha Ammersdoerfer, Frontenhausen (DE)

Correspondence Address: Mann+Hummel GMBH, Dept: VR-P Plant 5.4, Hindenburgstr. 45, Ludwigsburg, 71638, DE

(73) Assignee: MANN+HUMMEL GMBH, Ludwigsburg (DE)

(21) Appl. No.: 12/189,873

(22) Filed: Aug. 22, 2008

(30) Foreign Application Priority Data
Aug. 17, 2007 (DE) 20 2007 011 586.5

(51) Int. Cl. B01D 46/52; B29C 51/00

(52) U.S. Cl. 55/497; 264/339; 264/442; 264/443

(57) ABSTRACT

A filter element has a fold pack having sides. A lateral strip at least partially surrounds the sides of the fold pack. The lateral strip is made of thermally deformable lateral strip material. At least one guide section projects laterally from the filter element and is made from the thermally deformable lateral strip material. In a method for producing such a filter element, a fold pack is at least partially secured with a lateral strip made of a thermally deformable lateral strip material and the lateral strip material is then thermally deformed to a guide section that projects laterally from the filter element.

### TECHNICAL FIELD

The present invention relates to filter elements having folded filter media and, more particularly, to interior filters for filtering air for the passenger compartment of a motor vehicle.

### BACKGROUND OF THE INVENTION

The present invention relates to a filter element, in particular an interior filter for filtering air for the passenger compartment of a motor vehicle. Moreover, the invention concerns a manufacturing process for such a filter element.

Such a filter element serves for filtering fluid streams or gaseous media, for example, for filtering an air flow supplied to the passenger compartment of a motor vehicle. Even though applicable to any type of filter element, the present invention as well as the problems to be solved by it are disclosed in the following in connection with a filter element for filtering air for the interior or passenger compartment of a motor vehicle. In the following, such filters are referred to as motor vehicle interior air filters or interior air filters or cabin air filters.

The increasing air pollution, in particular in large cities, in connection with utilization of modern air-conditioning systems makes it desirable and also necessary to purify by means of suitable filters the air that is supplied from the environment to the interior of a motor vehicle and treated or air-conditioned. For this purpose, for example, particle filters, odor-removing filters or combinations of such filters with one another are considered that remove by filtration or absorb the contained suspended solids, particles and odors from the ambient air as best as possible. Such filters for filtering air for the interior of a motor vehicle are generally known in a variety of embodiments and variants so that their construction and function is only briefly explained in the following.

Since the effectiveness of filters depends especially on the size of the surface area of the filter through which the air passes, for motor vehicle interior air filters primarily zigzag-folded filter media, also referred to as pleated filter media, are utilized. The type of folding of the employed filter media, as a result of the fold height, the fold spacing and the degree of compression of these accordion-like filter packs of the different folded sections of the filter media, enable an enlargement of the filter surface area through which the air stream flows. In order to be able to handle more easily such filter elements with zigzag-folded filter media in particular with regard to assembly, reinforcement elements are often provided on the sides of the filter element alongside the filter pack of folded medium. These reinforcement elements serve for lateral fixation and stabilization of the zigzag-shaped filter medium and are attached by means of a suitable adhesive to the sides of the fold pack. With respect to assembly, the filter element provided with bracing or reinforcements in the form of strips attached along the folded longitudinal sides can be inserted easily without damaging it into a housing of a filter module or an appropriate filter receptacle, for example, into a filter housing or an air-conditioner of a motor vehicle.

Similar filter elements are disclosed in the European patent EP 1 309 386.

In addition to the necessity of stabilization of the filter elements or filter inserts, it is also necessary that they are seal-tight at the edge areas relative to the corresponding housings so that the air to be filtered flows substantially through the filter medium or the filter pack and does not bypass it Circumferentially extending rails or laterally projecting guide means are moreover necessary in order to position the respective filter element on a contact surface surrounding an opening or to push it into a matching receptacle or housing opening. In the aforementioned European patent, a flexible frame is disclosed, for example, that is injection molded from plastic material about the fold pack in order to insert the filter into a matching receiving opening, for example, of the motor vehicle.

It is moreover desirable that these filter elements, in addition to the simple mounting-relevant manipulation, should also be inexpensive and therefore in particular should be producible in a way as simple as possible. In this connection, it is also desirable to employ as little filter material as possible, for example, nonwoven filter material, and to carry out the manufacture in only a few steps.

In view of this background, the present invention has the object to provide an improved filter element that can be produced in a simple way and has means for controlled insertion into a suitable receiving opening.

### SUMMARY OF THE INVENTION

In accordance with the present invention this object is solved by a filter element comprising a fold pack and a lateral strip that at least partially surrounds the sides of the fold pack wherein the lateral strip is comprised of a thermally deformable lateral strip material and has at least one guide section that projects laterally from the filter element and is comprised of the thermally deformed lateral strip material.

Accordingly, a filter element is provided, in particular an interior air filter for a motor vehicle, comprising a fold pack and a lateral strip. The lateral strip surrounds at least partially the fold pack and is comprised of a thermally deformable lateral strip material. At least one guide section of thermally deformable lateral strip material that projects laterally from the filter element is formed.

Preferably, the guide section and the lateral strip are monolithic with regard to the material wherein the guide section is formed by thermal deformation of the lateral strip.

The filter element can be produced especially with reduced expenditure because the lateral strip is bent by thermal deformation and forms a laterally projecting guide section. It is therefore not necessary to add or secure several parts to a fold pack that is surrounded by a lateral strip. Since the guide section is manufactured of the same material as the lateral strip, the same manufacturing tools can be employed.

The lateral strip material can moreover be compressible and the guide section can be formed of compressed lateral strip material. A lateral strip material in the form of a nonwoven, for example, felted PET, is also conceivable. During thermal deformation, melting of the exterior layers of the nonwoven material or lateral strip material can occur so that the latter becomes pliable and can be easily bent to form the guide section.

In one embodiment of the filter element the fold pack has several fold sections formed by folds which are secured by gluing to the lateral strip. The fold pack can be coated with active carbon in order to provide an additional adsorption effect. In order to stabilize the folds further, it is also conceivable to heat the nonwoven material and to fix it in this way in the folded position

A preferred embodiment of the filter element has two lateral strip parts each having a respective guide section; between the lateral strip parts the fold pack is secured. This embodiment requires only three individual elements that are to be assembled in the manufacturing process.

Preferably, the guide section is reinforced by thermal deformation and/or compression in such a way that the filter element is supported by one or several guide sections on a support of a filter holder. The guide sections serve to secure the entire filter element, for example, in a housing.

The fold pack has, for example, a height parallel to a flow direction and the lateral strip has a holding section having a width that matches the height wherein the guide section is positioned at a non-vanishing angle relative to the holding section. Preferably, the guide section projects substantially perpendicularly relative to the lateral strip and the holding section.

The invention concerns moreover a method for producing a filter element wherein a fold pack is at least partially secured by means of a lateral strip comprised of a thermally deformable lateral strip material, wherein the lateral strip material is thermally deformed for forming a guide section projecting laterally from the filter element.

Such a method can be implemented in an uncomplicated way. For example, the thermal deformation can be realized by means of heat radiation and possibly additional pressure applied onto a section of the lateral strip. The thermal deformation can be assisted at the same time by bending the lateral strip material to a guide section. Other methods employing hot air, ultrasound, vibrations or light, for example, visible or infrared light, are conceivable.

In a variant of the manufacturing method the thermal deformation of the lateral strip material is realized by supplying heat and, at the same time, compressing the lateral strip material. A similar process is realized, for example, when ironing a non-woven material or felted material by means of a hot iron.

In a further variant of the method, first the fold pack is glued to a holding section of the lateral strip. Subsequently, for forming the guide section, by means of a heated roll and a contact surface a section of the lateral strip that adjoins the holding section is bent by thermal deformation and compression for forming the guide section. Conceivable is, for example, deformation, compression, and bending in a production line.

The invention further concerns a filter element that is produced in accordance with such a manufacturing process.

Further advantageous embodiments and developments of the invention are disclosed in the dependant claims and in the embodiments described in the following.

### BRIEF DESCRIPTION OF THE DRAWING

FIG. 1 shows a perspective view of a first embodiment of a filter element according to the invention.

FIG. 2 is a perspective view of a second embodiment of the filter element according to the invention received in a receptacle.

FIG. 3 shows possible shapes of thermally deformed lateral strip materials.

FIG. 4 shows a perspective view of the first embodiment of a filter element according to the invention during its manufacture.

FIG. 5 illustrates another manufacturing method.

In the Figures same or functionally identical elements, if not specified otherwise, are referenced by same reference numerals.

### DESCRIPTION OF THE PREFERRED EMBODIMENTS

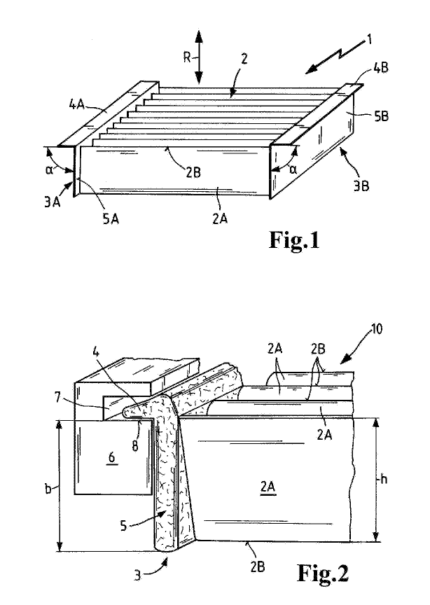

In FIG. 1 a perspective illustration of a first embodiment of a filter element is illustrated. For this purpose, first a fold pack 2 is provided that is formed of accordion-folded fold sections 2A that are delimited by their respective fold edges 2B. The arrow R indicates a possible flow direction through the fold pack. In FIG. 1 only the fold section 2A and the fold edge 2B at the end face are referenced with reference numerals. Laterally, the fold pack 2 is secured by two lateral strip parts 3A, 3B. For example, an adhesive connection can be provided between the lateral strip 3A, 3B and the fold pack 2. The lateral strip material is thermally deformable, for example, is comprised of a nonwoven material. A possible nonwoven material is comprised of polyethylene terephthalate (PET) fibers that are felted and that when exposed to heat, for example, will begin to melt and thus make the entire nonwoven material easily deformable. The lateral strip has moreover guide sections 4A, 4B that project laterally from the entire filter element 1. The two lateral strip parts 3A, 3B have thus a lower holding section 5A, 5B with which the folds of the fold pack 2 are secured and a guide section 4A, 4B that projects preferably at a right angle from the holding section 5A. The deformation is achieved according to the invention by applying heat.

In FIG. 2 a second embodiment of the inventive filter element is illustrated in a perspective view. However, only a detail is shown. The filter element 10 has a lateral strip 3 with a holding section 5 and a guide section 4 that is formed by thermally deforming the lateral strip material. The folds of the fold pack 2 are e.g. glued onto the holding section 5. FIG. 2 shows several fold sections 2A that are delimited by the folds or the fold edges 2B. The angle of the folds 2B determines the height h of the fold pack.

The guide section 4 is inserted into a receptacle 7, for example, a receptacle of a housing 6. By means of the guide section 4 the filter element 10 is, for example, secured in the housing 6. Moreover, depending on the orientation of the inserted filter element 10, the guide section 4 can be designed such that it supports the weight of the entire filter element 10 and will rest on the contact surface, referenced by reference numeral 8, of the receptacle 6. The holding section 5 has in the embodiment illustrated in FIG. 2 a width b that correspond substantially to the height h of the fold pack 2.

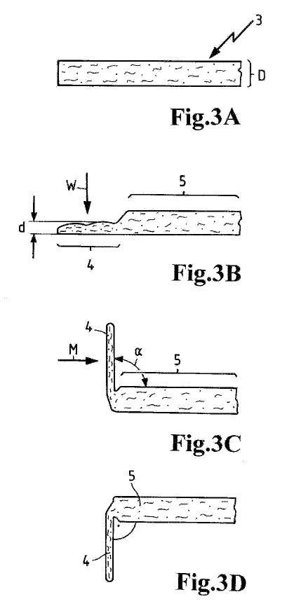

FIG. 3 shows possible states of a thermally deformable lateral strip during manufacture of the filter. FIG. 3A shows a lateral strip 3. The lateral strip is comprised of a material that is thermally deformable. Many materials are conceivable for this purpose, for example, foamed material, plastic fibers that are felted, or even full plastic (synthetic) material. Appropriate materials are also referred to as thermoplastic materials that can be deformed within a certain temperature range. Thermoplastic materials can be welded together by supplying heat and pressure. Known are, for example, polyethylene (PE), polystyrene (PS), polyvinyl chloride (PVC), polyamide (PA) but also celluloid. From all these materials, nonwoven materials can be produced by felting appropriate fibers.

The examples illustrated in FIG. 3 are based on a nonwoven material that has thickness D. The lateral strip is, for example, first present as a nonwoven strip 3. In order to form the guide section first, as illustrated in FIG. 3B, the nonwoven material is heated in the area of the guide section 2 by applying heat and/or pressure, illustrated by arrow W. Accordingly, at the surface of the lateral strip the fibers melt and compress the material in the guide section 4. The corresponding holding section 5 is not thermally treated. In this way, for example, a reduced thickness d≦D for the guide section 4 results. The heat can be applied, for example, by hot air but also in a targeted fashion by irradiation with ultrasound so that the molecules of the nonwoven material are excited to perform vibrations which causes heat to develop. Ultrasound can be introduced in a targeted fashion so that the guide section can be well defined.

Subsequently, as illustrated in FIG. 3C, by mechanical action M the guide section 4 can be bent appropriately. In this connection, the holding section 5 is positioned relative to the guide section 4 at an angle α. This angle α can be preferably 90 degrees. FIG. 3D shows also a thermally deformable lateral strip with a holding section 5 and a guide section 4 wherein the sections 4, 5 are positioned at an angle of 90 degrees. By bilaterally pressing the guide section 4, for example, in the way of two irons that are pressed against one another, the guide section 4 can be embodied to be especially flat.

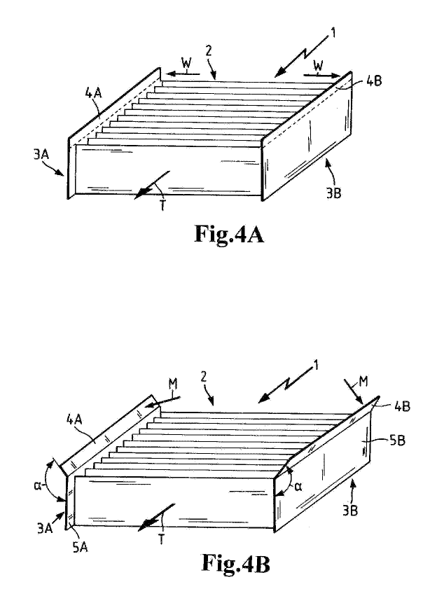

In FIGS. 4A and 4B, the states of an embodiment of a filter element during the manufacturing process are shown in perspective illustration. When manufacturing the filter element 1, for example, first the fold pack 2 is glued to the lateral strip parts 3A, 3B and is placed subsequently, for example, on a transport belt so that the premanufactured filter elements 1 are transported in transport direction T. During transport the sections of the lateral strip parts 3A, 3B that are to be formed as guide sections 4A, 4B can be treated with heat, for example, by irradiation with ultrasound or by applying hot air. This is indicated in FIG. 4A by arrows w.

After the premanufactured filter element 1 has been transported farther, the respective guide section 4A, 4B can be bent by mechanical action M, as shown in FIG. 4B by means of arrows M. This is realized until the desired angle α, for example, 90 degrees, is reached, as illustrated in FIG. 1. Subsequently, for example, the corresponding areas of the lateral strips 3A, 3B, i.e., in particular the guide sections 4A, 4B, can be cooled so that a fixation in a position laterally projecting from the filter element is achieved.

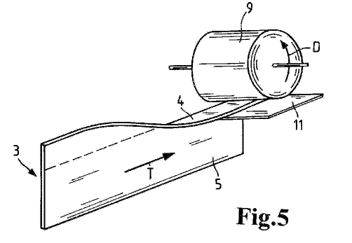

A combination of heat and mechanical action on the lateral strip sections that are provided as guide sections 4A, 4B can also be achieved by a heated roll that presses the guide sections 4A, 4B against a corresponding support surface. This is indicated in a perspective view in FIG. 5. In FIG. 5 only the lateral strip 3 and not the fold pack is illustrated.

The lateral strip 3 is transported in the transport direction T and is partially pressed by a rotating heated roll 9 against a contact surface 11. In this way, the lower holding section 5 shown in FIG. 5 and the guide section 4 that is formed by thermally deformed lateral material are produced. In this way, a simple embodiment of the lateral strip 3 formed monolithically with guide section 4 and holding section 5 is enabled. The thermal deformed lateral strip material is moreover particularly stable and enables a safe insertion into, for example, a housing opening or suitable guide rail.

Even though the present invention has been explained in more detail with the aid of preferred embodiments, it is not limited to these embodiments but can be modified in several ways. It is possible to employ geometries that differ from the illustrated ones for the filter elements. In this connection, the conditions at the installation location can be taken into consideration. Moreover, additional embodiments with lateral strips and guide sections that completely surround the fold pack are possible. The mentioned materials for thermally deformable lateral strip material are also to be understood only as non-limiting examples.

While specific embodiments of the invention have been shown and described in detail to illustrate the inventive principles, it will be understood that the invention may be embodied otherwise without departing from such principles.

What is claimed is:

1. A filter element comprising:
a fold pack having sides; and
a lateral strip that at least partially surrounds said sides of said fold pack;
wherein said lateral strip is comprised of a thermally deformable lateral strip material; and
at least one guide section projecting laterally from the filter element and made from said thermally deformable lateral strip material.

2. The filter element according to claim 1, wherein said at least one guide section and said lateral strip are of same material and monolithic, wherein said at least one guide section is formed by thermal deformation of said lateral strip.

3. The filter element according to claim 1, wherein said lateral strip material is compressible and wherein said at least one guide section is comprised of said lateral strip material that is compressed.

4. The filter element according to claim 1, wherein said fold pack has several fold sections formed by folds, wherein said fold sections are secured by a glue connection to said lateral strip.

5. The filter element according to claim 1, wherein said lateral strip is comprised of two lateral strip parts each provided with one of said at least one guide section, wherein said two lateral strip parts are secured to opposite ones of said sides of said fold pack.

6. The filter element according to claim 1, wherein said at least one guide section is reinforced by thermal deformation; by compression; or by thermal deformation and compression in such a way that the filter element is supported by said at least one guide section on a support of a filter holder.

7. The filter element according to claim 1, wherein said fold pack has a height extending in a direction that is parallel to a flow direction of a medium to be filtered by the filter element, wherein said lateral strip has a holding section having a width that matches said height, and wherein said at least one guide section projects at a non-vanishing angle from said holding section.

8. The filter element according to claim 1, wherein said at least one guide section extends substantially perpendicularly relative to said lateral strip.

9. The filter element according to claim 1 to 8, wherein said at least one lateral strip material is comprised of a nonwoven material

10. The filter element according to claim 9, wherein said nonwoven material is felted PET.

11. A method for producing a filter element, the method comprising the steps of:
securing at least partially a fold pack with a lateral strip made of a thermally deformable lateral strip material; and
thermally deforming said lateral strip material to a guide section that projects laterally from the filter element.

12. The method according to claim 11, wherein, in the step of thermally deforming, a section of said lateral strip is subjected to heat radiation or ultrasound irradiation.

13. The method according to claim 11, wherein, in the step of thermal deforming, an outer layer of said lateral strip material is melted.

14. The method according to claim 13, wherein said outer layer is an outer layer of a nonwoven material.

15. The method according to claim 13, wherein, in the step of thermally deforming, said lateral strip material is bent to said guide section.

16. The method according to claim 11, wherein the step of thermally deforming is carried out by applying heat and simultaneously compressing said lateral strip material.

17. The method according to claim 11, wherein, in the step of securing, said fold pack is glued to a holding section of said lateral strip and, in the step of thermally deforming, a section of said lateral strip, which section adjoins said holding section, is bent at an angle to form said guide section by applying a heated roll onto said section that is resting against a support surface and compressing said section.

18. A filter element produced according to the method of claim 11.
